(19) United States
(12) Patent Application Publication
(10) Pub. No.: US 2015/0034229 A1
(43) Pub. Date: Feb. 5, 2015

(54) SONOTRODE TOOL HAVING AN INTEGRATED COOLING DEVICE

(71) Applicant: PP-TECH GMBH, Ettingen (DE)

(72) Inventor: Marco Ochs, Ettlingen (DE)

(21) Appl. No.: 14/449,651

(22) Filed: Aug. 1, 2014

(30) Foreign Application Priority Data
Aug. 1, 2013 (DE) 102013215106.3

(51) Int. Cl. B32B 37/08

(52) U.S. Cl. CPC B32B 37/08; B32B 2309/00
USPC 156/73.1; 156/498

(57) ABSTRACT

The invention relates to a sonotrode (100; 100′; 100″), comprising a sonotrode body (10; 10′; 10″), which has at least one contact region (12; 12′; 12″) for applying high-frequency mechanical vibrations, introduced at at least one introduction region (14; 14′; 14″) of the sonotrode body (10; 10′; 10″) by a vibration unit, to at least one workpiece (200; 200′; 200″) or material or to a further tool acting thereon, and a heat dissipation device, by means of which heat can be dissipated from the contact region.

### RELATED APPLICATIONS

This application claims priority to German Application Serial Number 10 2013 215 106.3, filed Aug. 1, 2013, which is incorporated by reference herein in its entirety.

### DESCRIPTION

The present invention relates to a sonotrode or sonotrode tool, comprising
a sonotrode body, which has at least one contact region for applying high-frequency mechanical vibrations, introduced at at least one introduction region of the sonotrode body by a vibration unit, to at least one workpiece or material or to a further tool acting thereon, and
a heat dissipation device, by means of which heat can be dissipated from the contact region.

Sonotrode tools for introducing high-frequency mechanical vibrations into workpieces and materials, for example when welding plastics material components and film materials, are known. In this context, power in the form of ultrasound is introduced to a point on the component or material by means of a vibrating sonotrode, and induces boundary friction and molecular friction between the components or materials at another point, for example a joining point to a second component to be connected thereto, and is thus released in the form of heat.

When a product is welded at automated high cycle times (for example in the field of packaging), a high heat flow occurs on the average, and is introduced into the sonotrode at the tip thereof (generally at the “contact region”). If this heat is not sufficiently dissipated, the temperature of the contact region increases. In the most unfavourable case, the plastics material of the component is softened as a result of the high temperature of the sonotrode tool.

In conventional heat dissipation devices in the sonotrode tool according to GB 952,042 or DE 10 2008 029 769 A1, with constant use of a supplied coolant which flows through the sonotrode, not only is the heat which is absorbed by the sonotrode at the contact region dissipated, but the whole sonotrode body is also cooled. Technical means such as inlet and outlet lines and a pump are required for this purpose.

As a result of technical means of this type and likewise of an external cooling device, which is required for cooling the coolant and the configurations of which are independent of the respective sonotrode forms, it is obvious that not only are heat dissipation devices expensive to install and to operate, so that they necessarily involve high setup and operating costs, but they may also be fault-prone in operation.

The object of the invention is therefore to provide a sonotrode tool having a heat dissipation device in such a way that the temperature applied at the contact region of the sonotrode can be reduced cost-effectively and reliably in a simple manner.

To achieve this object, for the sonotrode mentioned above, it is proposed for the heat dissipation device to comprise a heat transportation device, which is formed in the sonotrode body and is configured to dissipate heat from the contact region and supply it to at least one other region of the sonotrode body.

In accordance with an important feature of the invention, the heat transportation device is provided entirely in the interior of the sonotrode body, in such a way that the temperature application at the contact region of the sonotrode and thus at the corresponding point on the component is reduced without external technical means. The undesirable softening of a component, material or the like which is to be welded is thus prevented, without major outlay for equipment being required.

The heat transportation device can be manufactured separately and inserted, as a prefabricated part, into a separately manufactured sonotrode body. For example, the sonotrode body may initially be manufactured as a homogeneous body, and a region may subsequently be hollowed out from the interior of the sonotrode body and provided with the heat transportation device. Alternatively, the sonotrode body may be shaped around the heat transportation device, depending on the material of the sonotrode body and the nature and configuration of the heat transportation device.

The heat transportation device according to the invention ensures a more uniform temperature distribution over the length or generally over different regions of the sonotrode, and thus over the surface thereof, increasing the dissipation of heat to the environment. The sonotrode body thus itself acts as part of the heat dissipation device, and so the cooling effect is achieved cost-effectively and efficiently.

In a preferred embodiment of the invention, the heat transportation device comprises a material which is embedded in the sonotrode body and which has a higher thermal conductivity than the material of the sonotrode body surrounding the embedded material. There are basically no limitations on the nature and consistency of the embedded material. Thus, solid, liquid or powdered material may be considered.

It is particularly conceivable for the embedded material to be present in the sonotrode body in the form of at least one solid core. A sonotrode tool of this type can be manufactured particularly cost-effectively. Nevertheless, good heat dissipation from the contact region is achieved. In general, the sonotrode body is made of titanium, titanium alloys or steel, because of the frequently very high mechanical loads in operation during welding at a high frequency and possibly a high amplitude. Accordingly, the surrounding material of the sonotrode body may be titanium, a titanium alloy or steel. By contrast, aluminium is predominantly intended to be used as the embedded material. It is also possible to use copper. These materials are distinguished by particularly high thermal conductivity.

In a further embodiment of the invention, in at least one cavity formed in the sonotrode body the thermal transportation device comprises a cooling fluid, which is in the liquid phase at least in part and which can be evaporated adjacent to the contact region to dissipate heat therefrom and condensed into the liquid phase on a condensation surface at at least one point remote from the contact region. Advantageously, it may be provided that, when latent heat is used in the evaporation and condensation, the heat can be transported rapidly and effectively from the contact region to the condensation surface. It can be ensured that the condensed coolant is fed back towards the contact region. The heat transportation device can thus advantageously operate in the manner of a heat pipe or thermosiphon.

The cavity of the heat dissipation device can be filled with liquid phase of the coolant up to a fill level. The remaining space can be filled with the vapour phase of the same coolant. The liquid phase and vapour phase of the coolant may advantageously be in the saturation state. If the sonotrode body is now heated at the contact region during operation, the liquid phase of the coolant evaporates (or evaporates at a higher rate) and condenses on the condensation surface (or condenses at a higher rate), resulting in effective transportation of heat away from the contact region. The heat transportation device thus formed has a very low thermal resistance. In the interior of the cavity, in particular in the region between the contact region and the condensation surface, an approximately isothermic state is established. The fill level of the liquid phase is substantially maintained.

The coolant is to be selected in accordance with the expected temperatures or expected application of heat. One condition on this selection is that the coolant must be present both in the liquid and in the vapour phase during operation, and be able to condense on the condensation surface on the basis of the temperature gradient occurring during operation over the extent of the sonotrode body. For example, water may be selected as a coolant, and not only is cost-effective, but also makes environmentally friendly operation of the heat dissipation device possible. In this way, if a sonotrode body breaks and coolant thus leaks out, no damage will be done.

Preferably, the liquid phase can be conveyed towards the contact region by gravity. This makes a particularly simple construction of the heat transportation device possible, since it merely requires a gas-tight cavity filled in part with a liquid coolant.

It is generally proposed for the condensed liquid phase to be guided back in the manner of a thermosiphon. Alternatively or in addition, it may be possible to convey the liquid phase towards the contact region by capillary action of at least one capillary structure of the sonotrode body and/or of a material accommodated in the cavity. The condensed phase can thus be fed back in the manner of a heat pipe, in such a way that the heat transportation device works in any desired orientations of the sonotrode body.

The capillary action can be achieved by longitudinal channels (such as the “grooves” known from heat pipes) in the internal surface of the sonotrode body which defines the cavity or in a defining wall of an element separate from the sonotrode body and comprising the cavity and/or by at least one fine-mesh netting (such as the “wicks” known from heat pipes), for example made of copper, which is arranged in the cavity and extends for example around a free interior of the cavity.

It should be noted that good dissipation of heat can also be achieved by using only one phase of a cooling fluid. In at least one cavity formed in the sonotrode body, the heat transportation device may thus comprise a cooling fluid, which is in the liquid or gaseous phase, so as to achieve transportation of heat by simple convection. Convection of the coolant, and thus heat transportation, are achieved by the coolant simply on the basis of gravity. Because of the lower specific density of the medium which is hotter from absorbing heat, it is lighter than the cooler medium and accordingly rises upwards, whilst the colder medium sinks downwards. This type of cooling is also known as thermosiphon cooling. Thus, the term “thermosiphon” does not necessarily involve the use of a phase transition to absorb heat by evaporation and emit heat by condensation.

It is preferably provided that to form the cavity a clearance in the sonotrode body is closed by a closure. The closure may be configured as a sealant to seal off the clearance or may comprise a separate sealant, in such a way that the cavity is sealed to be completely gas-tight when closed. The closure may for example comprise a screw element which can be screwed to the sonotrode body or to an element separate therefrom. The closure may also alternatively comprise an element which can be fixed using a press fit. It is also possible for the closure to be fixed in a material fit, especially by welding the closure to the sonotrode body or to the separate element comprising the cavity.

The closure may advantageously be formed with a valve for evacuating the cavity or removing gases in the cavity. This further makes it possible to evacuate the cavity in a simple manner, in such a way that the heat transport from the contact region to the condensation surface via the gaseous phase of the coolant is not obstructed by other gases.

A particularly expedient configuration of the sonotrode is distinguished in that the sonotrode body comprises the introduction region at one end and the contact region at an opposite end. The sonotrode body may be of a wide range of shapes, as is known per se in the field. For example, the sonotrode body may taper at least in regions from a base portion of the sonotrode body, comprising the introduction region, to the contact region, provided at a tip of the sonotrode body if desired.

However, it is also possible for the sonotrode body to be of a different shape. Conceivable configurations include a sonotrode body in the form of a rotatable roller, for example in accordance with EP 1 900 499 A2, having a contact region on the side wall of the roller, or an elongate sealing body for producing long sealed seams. Without loss of generality, reference is made for example to WO 2011/117119 A1 and EP 2 058 109 A1.

It should further be noted that the inventive proposals and development proposals do not relate exclusively to applications of the sonotrode tool in ultrasound welding or ultrasound sealing. A sonotrode tool according to the invention may also be used in other ultrasound-based applications, for example for ultrasound vibration lapping and other ultrasound-based processing methods in which potentially undesirable heating of the sonotrode tool occurs at at least one contact region.

In the following, the invention is described in greater detail by way of the embodiments shown or illustrated in the drawings.

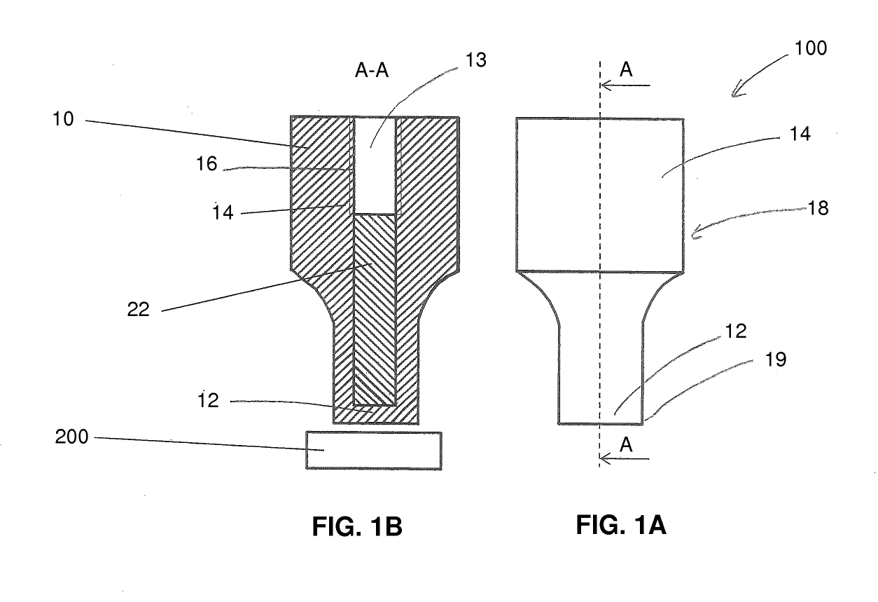

FIG. 1A shows a side view of a sonotrode tool in accordance with a first embodiment of the invention on the right and FIG. 1B shows a cross-sectional view along a section line A-A on the left.

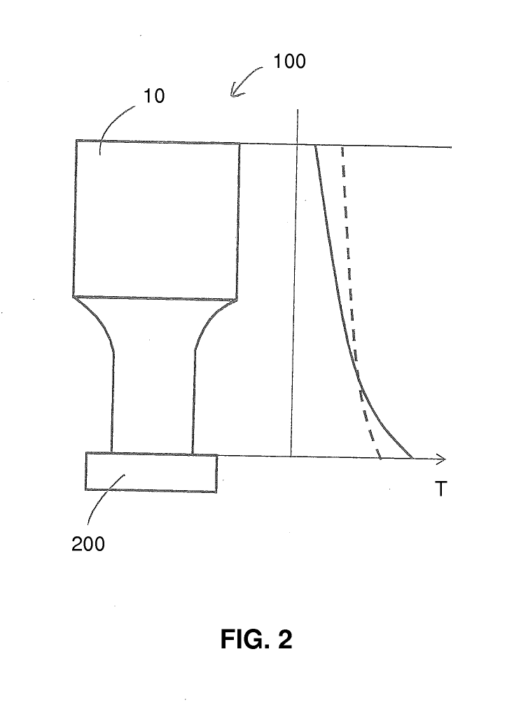

FIG. 2 shows effects of the invention on the temperature distribution in a sonotrode body.

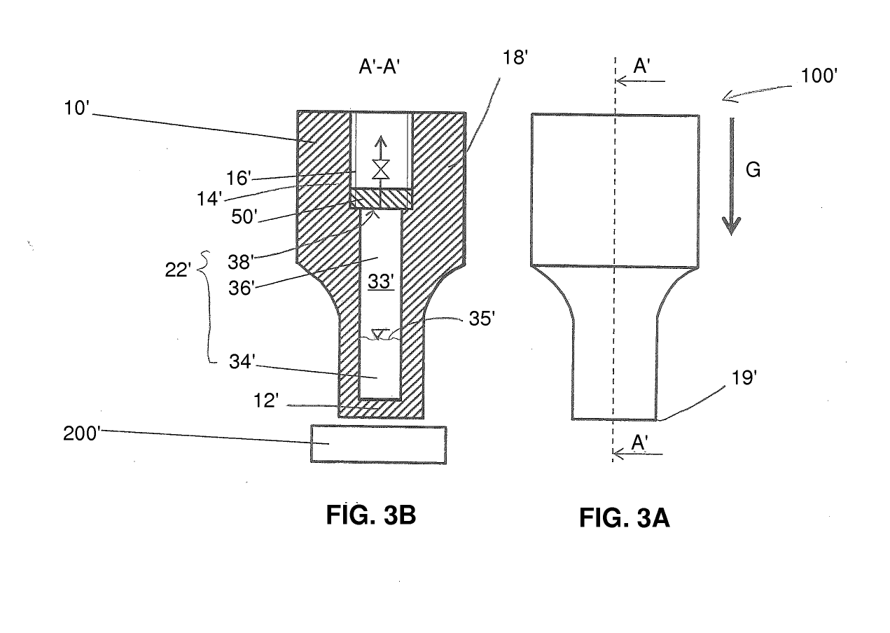

FIG. 3A shows a side view of a sonotrode tool in accordance with a second embodiment of the invention on the right and FIG. 3B shows a cross-sectional view along a section line A′-A′ on the left.

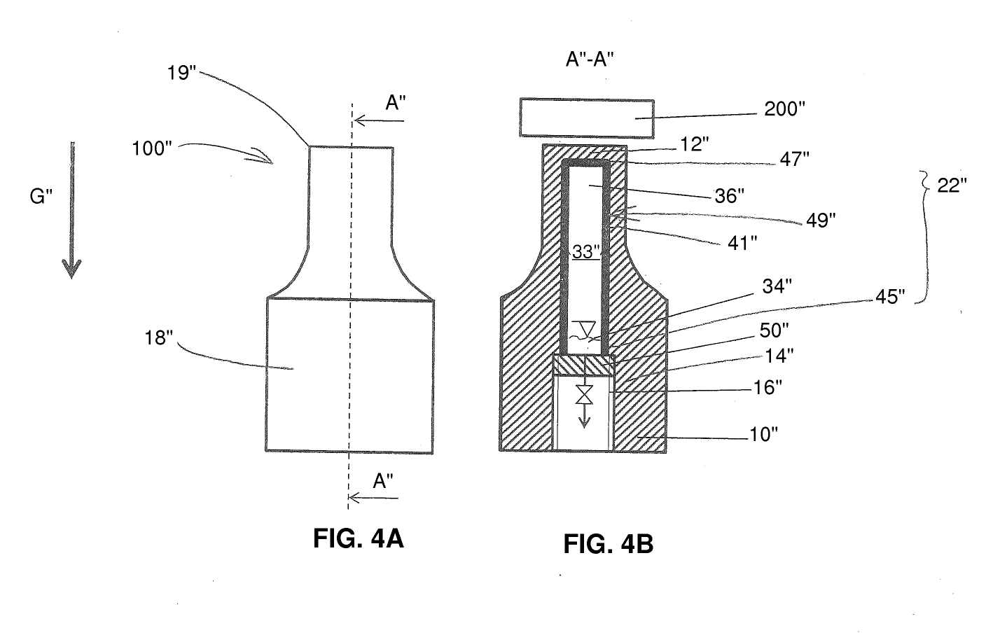

FIG. 4A shows a side view of a sonotrode tool in accordance with a third embodiment of the invention on the left and FIG. 4B shows a cross-sectional view along a section line A″-A″ on the right.

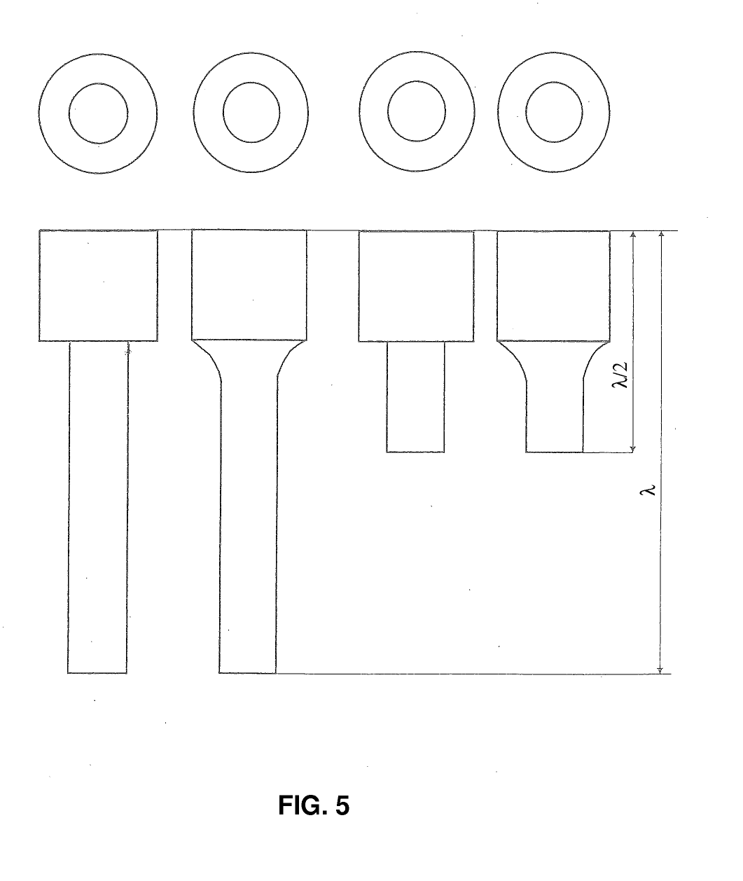

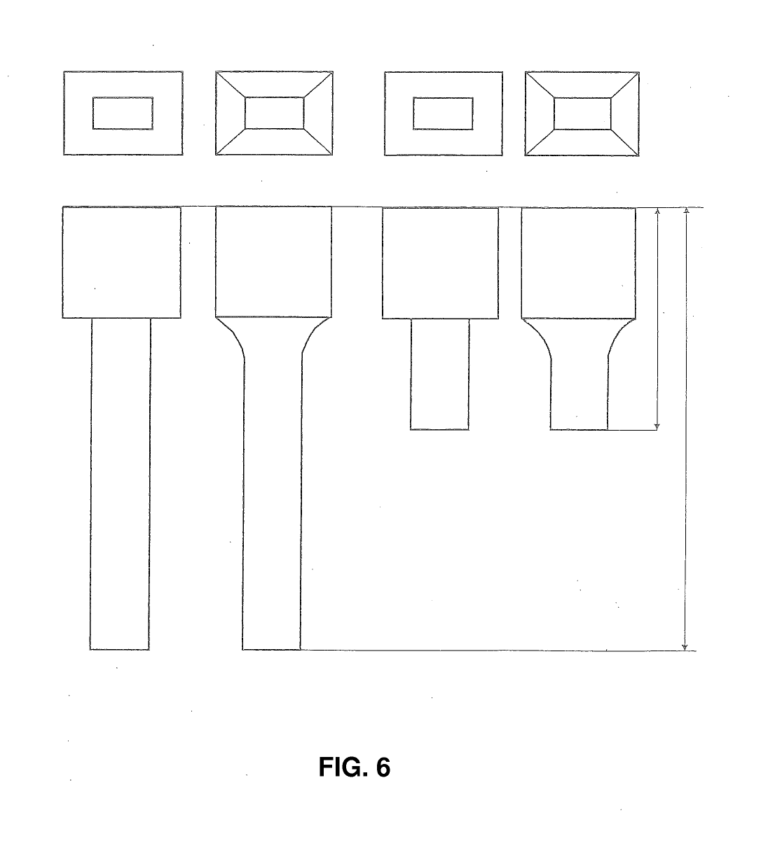

FIG. 5 and FIG. 6 each show four non-limiting examples of sonotrode bodies of a sonotrode tool, in accordance with the invention in each case, which bodies can be equipped with a heat dissipation device according to the invention for cooling.

In FIG. 1A, a sonotrode tool according to the invention is denoted as 100 as a whole. In the embodiment shown, a sonotrode body 10 of the sonotrode tool is formed with an introduction region 14 at one end and a contact region 12 at the opposite end, and extends in the region of space between the introduction region 14 and the contact region 12. Further, the sonotrode body 10 tapers from a base portion 18, comprising the introduction region 14, to the contact region 12, provided at a tip 19 of the sonotrode body. The base portion 18 is configured with a cylindrical recess 13, which is configured on an internal circumference with an internal thread 16 which is used for screwing to a complementary holding element of an ultrasound generator, by means of which ultrasound can be introduced into the sonotrode body.

In a known manner, the sonotrode tool 100 serves to load a tool 200 to be machined, in particular to weld the workpiece 200 to another workpiece (not shown), in that the contact region 12 of the sonotrode tool is brought into contact with the workpiece, in such a way that the ultrasound is introduced into the workpiece. The sonotrode body thus performs an adaptation function. Boundary friction and molecular friction between the workpieces subsequently result in the heat required for welding, but said heat also leads to heating of the workpiece 200 in the proximity of the contact region 12 and thus to heating of the sonotrode body at the contact region.

Thermal power can thus be selectively supplied to a point at which for example it is desired to melt the material, such as plastics material, of the workpieces to be welded, by contrast with welding by external heat supply. However, the aforementioned heating of the sonotrode body via the contact region cannot be prevented and can lead to problems, for example in that temperatures are reached which could lead to softening of the plastics material of a component and thus to unacceptable welding results. This is also a problem primarily because the sonotrode body is generally made of a material of much lower thermal conductivity, for example titanium or steel, since the sonotrode body is regularly exposed to very high mechanical loads during operation. The heat dissipation by thermal conduction from the contact region 12 may thus be too poor to dissipate the heat sufficiently. FIG. 2 shows schematically the spatial temperature progression along a sonotrode body for a conventionally configured sonotrode (solid line) and for a sonotrode according to the invention (dashed line). For the conventional sonotrode, a temperature maximum occurs at the contact region with the workpiece 200, from which the temperature subsequently falls off comparatively steeply, this being due to insufficient thermal conduction in the sonotrode body.

According to the invention, however, better distribution of heat over the extension of the sonotrode is achieved by improving the thermal conduction in the sonotrode body, as is clear from the dashed line in the temperature diagram of FIG. 2. The temperature maximum is still at the contact region, but is reduced considerably by comparison with a conventional sonotrode, and this is accompanied by a much lower fall in temperature over the length of the sonotrode as a result of the better thermal conduction according to the invention. Since the sonotrode body is heated as a whole, and thus not only at the contact region and portions of the sonotrode body in close proximity to the contact region, there is also a larger surface available for dissipating the heat to the outside, and so the heat is not only distributed better over the sonotrode body, but also emitted to the outside at a higher rate by radiation and interaction with the ambient air.

There are various conceivable possibilities for achieving the better heat distribution according to the invention and thus better heat dissipation to the outside according to the invention, without external means. FIG. 1A and FIG. 1B show a particularly simple solution. By embedding a core 22 of a material having much higher thermal conductivity that the actual sonotrode material, for example an aluminium core, a “heat transportation device” 22 is provided. For this purpose, the core may be in direct surface contact with internal surfaces of the sonotrode body, in particular with an internal surface of the sonotrode body in close proximity to the contact region, in such a way that the heat is effectively absorbed by the core and dissipated over the extension of the core, and can thus be distributed over the extension of the sonotrode body. A sonotrode of this type can be manufactured in a simple manner. For example, a region is excavated from the interior of the sonotrode and the material having the higher thermal conductivity, aluminium in this example, is introduced. An advantage of this solution is the simplicity of implementation and the independence of the heat dissipation function from the orientation of the sonotrode with respect to the direction of gravitational acceleration.

Particularly effective dissipation of heat from the contact region can be achieved by the principles, known per se, of a heat pipe or thermosiphon, examples of this being shown in FIG. 3A, FIG. 3B, FIG. 4A and FIG. 4B. The embodiments of FIG. 3A, FIG. 3B, FIG. 4A and FIG. 4B are disclosed using the same reference numerals, with one or two dashes respectively added to indicate the respective embodiment. Only differences from the previously disclosed embodiment or embodiments will be described in the following.

In the sonotrode tool 100′ according to the invention, in accordance with the second embodiment of FIG. 3A and FIG. 3B, the external shape of the sonotrode body is identical to the sonotrode body 10 in accordance with the first embodiment of FIG. 1A and FIG. 1B. The sonotrode body 10′ thus comprises a contact region 12′ and an introduction region 14′, and the base portion 18′ thereof is connected to an ultrasound generator.

In the embodiment, the sonotrode body is formed with an integrated thermosiphon. This can be achieved in a simple manner in that the sonotrode body 10′ is excavated from the inside, so as to form a cavity 33′ which is closed in a gas-tight manner by a closure 50′. The closure 50′ may expediently be formed with a valve (shown schematically in the drawing), via which the cavity can be evacuated and filled with a coolant, for example water, in the liquid phase 34′ as far as a fill level 35′. As a result of the previous evacuation, the remaining space of the cavity 33′ is filled with the vapour phase 36′ of the same coolant, and a saturation state (2-phase region) of the liquid phase and vapour phase of the fluid used as a coolant is established.

An alternative option is for the cavity initially to be filled with the liquid coolant 34′ at least as far as the fill level 35′, and subsequently to remove all foreign gases via the valve by drawing off vapour, so as to produce the saturation state of the cooling fluid. For this purpose, the initial fill level should be higher than the fill level intended to remain after the foreign gases are drawn off. If the cavity is freed of foreign gases, by initial evacuation and subsequent filling with cooling fluid or by drawing off vapour afterwards to remove the foreign gases, a saturation state is established at any temperature, as long as the temperature does not fall below the freezing point. Optimum removal of the foreign gas, in other words other gas or gases than the cooling fluid used, is to be recommended, and can also be achieved for example using turbomolecular pumps, which make it possible to achieve a very good vacuum.

Aside from evacuating the cavity or drawing off vapour to achieve a pressure corresponding to the vapour pressure of the coolant, there is also in principle a degree of freedom in the selection of the coolant. For normal applications, water in particular is suitable as a coolant, since water boils at a pressure of approximately 0.025 bar at room temperature (21° C.).

If heat is introduced at the contact region 12′ of the sonotrode body 10′ during operation, the liquid coolant 34′ evaporates and condenses at portions, remote from the contact region 12′, of the internal surface of the cavity and the internal surface of the closure 50′. These internal surfaces form a condensation surface 38′. The heat is thus transmitted to the condensation surface 38′ as latent heat. The primary condensation surface is the internal surface of the cavity, more precisely the region in contact with the vapour phase of the for example cylindrical internal surface of the cavity. The condensed coolant flows back to the reservoir of liquid coolant in the lower region of the cavity under gravity. The heat dissipation effect is thus achieved in the manner of a thermosiphon, making use of the circulation of the coolant under gravity due to the occurrence of convection, supplemented by the heat transportation due to the evaporation, which absorbs heat from the coolant reservoir, and the emission of the corresponding heat of condensation to the condensation surface during condensation. The thermosiphon formed in the embodiment thus to some extent forms a heat pipe with feedback of the condensed coolant under gravity. An approximately isothermic state is achieved in the interior of the cavity 33′. In FIG. 3A, the direction of gravitational acceleration G is shown by an arrow.

It should be noted that heat dissipation and heat distribution according to the invention can also be achieved by forming a more general thermosiphon, in which only convection of a gaseous or liquid coolant is used for the transportation of heat, in other words there is no phase transition which absorbs heat via a transition from the liquid phase to the gaseous phase, on the one hand, and emits heat by condensation back to the liquid phase, on the other hand. For this purpose, the entire cavity could be filled with a coolant of a particular phase, for example with water.

In the third embodiment in accordance with FIG. 4A and FIG. 4B, the sonotrode body is formed with an integrated heat pipe. For this purpose, similarly to the embodiment of FIG. 3A and FIG. 3B, the sonotrode body can be excavated to form a cavity 33″, and similarly to the second embodiment the resulting cavity can be closed by a closure 50″ which may comprise a valve for evacuating and filling with the coolant. As a result of the previous evacuation or the removal of foreign gases, a saturation state (2-phase region) of the coolant is established, in such a way that the cavity is filled with the liquid phase 34″ to a particular fill level and the remaining space is filled with the vapour phase 36″ of the same coolant.

The difference from the embodiment of FIG. 3A and FIG. 3B, having transmission of heat as latent heat by using two phases of a coolant, is that in the embodiment of FIG. 4A and FIG. 4B, feedback of the condensed medium towards the contact region is provided which is independent of the orientation relative to gravity, specifically being based on the capillary action of a capillary structure. For this purpose, an internal surface 49″, defining the cavity 33″, of the sonotrode body may be formed with a channel structure comprising longitudinal channels 41″, which transports the liquid coolant from a longitudinal channel region 45″, which dips into the reservoir of liquid coolant, to the region 47″ of the longitudinal channel adjacent to the contact region 12″, where the liquid coolant evaporates.

In FIG. 4A and FIG. 4B, the arrow indicates the direction of gravitational acceleration G, showing that in this embodiment the liquid coolant can be transported counter to gravity. This gaseous phase of the coolant, resulting from the evaporation, is distributed in the cavity and condenses at a particularly high rate on the colder regions of the internal surface 49″ of the cavity, and also on the surface of the liquid coolant reservoir. A resulting pressure gradient within the heat pipe, between the region where the coolant evaporates (where a locally increased pressure occurs) and the region where the coolant condenses again (where a locally reduced pressure is established), also brings about effective fluid circulation, which continuously transports heat away from the contact region 12″ and transmits it to other regions of the sonotrode, in such a way that overall a more uniform heat distribution in accordance with the dashed temperature line in FIG. 2 is achieved.

It should be noted that in addition or alternatively another type of capillary structure may also be implemented for feeding the liquid phase back to the contact region, for example a netting of fine metal wires or fibres, for example copper, known in the field as a wick.

FIG. 5 and FIG. 6 show example shapes of the sonotrode body. It should further be noted that different applications require different shapes of sonotrode body. A sonotrode according to the invention may also be of a completely different shape from what is shown in the drawings merely as an example. For example, sonotrode bodies having an annular contact region for continuously sealing plastics material films are known. Even in a sonotrode of such a completely different shape, the inventive proposal of targeted heat dissipation from the contact region through an integrated “heat transportation device”, without the need for external means for achieving the dissipation of heat, may advantageously be made use of.

What is claimed is:

1. A sonotrode (100; 100′; 100″), comprising:
a sonotrode body (10; 10′; 10″), which has at least one contact region (12; 12′; 12″) for applying high-frequency mechanical vibrations, introduced at at least one introduction region (14; 14′; 14″) of the sonotrode body (10; 10′; 10″) by a vibration unit, to at least one workpiece (200; 200′; 200″) or material or to a further tool acting thereon, and
a heat dissipation device, by means of which heat can be dissipated from the contact region,
characterised in that the heat dissipation device comprises a heat transportation device (22; 22′; 22″), which is formed in the sonotrode body and is configured to dissipate heat from the contact region (12; 12′; 12″) and supply it to at least one other region of the sonotrode body (10; 10′; 10″).

2. The sonotrode (100) according to claim 1, characterised in that the heat transportation device (22) comprises a material (22) which is embedded in the sonotrode body (10) and which has a higher thermal conductivity than the material of the sonotrode body (10) surrounding the embedded material.

3. The sonotrode (100) according to claim 2, characterised in that the embedded material (22) is present in the sonotrode body in the form of at least one solid core.

4. The sonotrode (100) according to claim 2, characterised in that the surrounding material of the sonotrode body (10) is titanium, a titanium alloy or steel, and the embedded material (22) is aluminium or copper.

5. The sonotrode (100′; 10″) according to claim 1, characterised in that the heat transportation device (22′; 22″) comprises a cooling fluid (34′, 36′; 34″, 36″) in at least one cavity (33′; 33″) formed in the sonotrode body (10′; 10″).

6. The sonotrode (100′; 100″) according to claim 5, characterised in that the cooling fluid (34′, 36′; 34″, 36″) is in the liquid phase (34′; 34″) at least in part and can be evaporated adjacent to the contact region (12′; 12″) to dissipate heat therefrom and condensed into the liquid phase on a condensation surface (38′; 49″) at at least one point remote from the contact region.

7. The sonotrode (100′) according to claim 6, characterised in that the liquid phase (34′) can be conveyed towards the contact region (12′) by gravity.

8. The sonotrode (100″) according to claim 6, characterised in that the liquid phase (34″) can be conveyed towards the contact region (12″) by capillary action of at least one capillary structure (41″) of the sonotrode body (10″) and/or of a material accommodated in the cavity (33″).

9. The sonotrode (100′) according to claim 5, characterised in that the cooling fluid is in the liquid or gaseous phase and serves to transport heat by convection.

10. The sonotrode (100′; 100″) according to claim 5, characterised in that to form the cavity (33′; 33″) a clearance in the sonotrode body is closed by a closure (50′; 50″).

11. The sonotrode (100′; 100″) according to claim 10, characterised in that the closure (50′; 50″) is formed with a valve for evacuating the cavity or removing gases in the cavity.

12. The sonotrode (100; 100′; 100″) according to claim 1, characterised in that the sonotrode body (10, 10′; 10″) comprises the introduction region (14; 14′; 14″) at one end and the contact region (12; 12′; 12″) at an opposite end.

13. The sonotrode (100; 100′; 100″) according to claim 12, characterised in that the sonotrode body (10; 10′; 10″) tapers at least in regions from a base portion (18; 18′; 18″) of the sonotrode body (10; 10′; 10″), comprising the introduction region (14; 14′; 14″), to the contact region (12; 12′; 12″), provided at a tip (19; 19′; 19″) of the sonotrode body (10; 10′; 10″) if desired.

14. A method of dissipating heat resulting from introducing high-frequency mechanical vibrations into at least one workpiece or material using a sonotrode tool and a vibration unit, said sonotrode tool having a sonotrode body (10; 10′; 10″), which has at least one introduction region (14; 14′; 14″) where high-frequency mechanical vibrations are introduced into said sonotrode body by said vibration unit and which has at least one contact region (12; 12′; 12″) in contact with said workpiece (200; 200′; 200″) or material, so that said high-frequency mechanical vibrations are applied to said workpiece or material,
wherein said sonotrode tool further comprises a heat dissipation device, by means of which heat is dissipated from the contact region,
wherein the heat dissipation device comprises a heat transportation device (22; 22′; 22″), which is formed in the sonotrode body and dissipates heat from the contact region (12; 12′; 12″) and supplies it to at least one other region of the sonotrode body (10; 10′; 10″).

15. The method according to claim 14, wherein heat supplied to the at least one other region of the sonotrode body (10; 10′; 10″) by means of said heat transportation device (22; 22′; 22″) is dissipated to the environment via an external surface of the sonotrode body.
